(19) United States
(12) Patent Application Publication
(10) Pub. No.: US 2024/0257031 A1
(43) Pub. Date: Aug. 1, 2024

(54) Lift Systems

(71) Applicant: IOTA, LLC, Saint Paul, MN (US)

(72) Inventors: Jacob Robert BJORKE, Mankato, MN (US); Daniel Elia CHAHLA, Saint Paul, MN (US)

(21) Appl. No.: 18/635,797

(22) Filed: Apr. 15, 2024

Related U.S. Application Data
(63) Continuation of application No. 15/872,862, filed on Jan. 16, 2018, now Pat. No. 11,961,158.
(60) Provisional application No. 62/446,831, filed on Jan. 16, 2017.

(51) Int. Cl. G06Q 10/08; G06F 16/23; G06K 19/06; G06K 19/07; G06Q 20/20; G06Q 30/018

(52) U.S. Cl. CPC G06Q 10/08; G06F 16/2379; G06K 19/06028; G06K 19/0723; G06Q 20/203; G06Q 30/0185

(57) ABSTRACT

A system for retailers is configured to monitor and track customer interaction with a product in a retail environment. The system utilizes RFID tagged products and communicating with near field communication in an Internet of Things environment for a more comprehensive relationship between customers and the products of interest. Where the products are not so connected, the system alerts the need for same.

### CROSS REFERENCE TO RELATED APPLICATIONS

This application is a continuation of U.S. patent application Ser. No. 15/872,862 filed Jan. 16, 2018, which claims the benefit of and priority to U.S. Provisional Patent Application No. 62/446,831 filed Jan. 16, 2017. The entire disclosures of the above applications are incorporated herein by reference.

### BACKGROUND

Customer shopping behaviors and engagement in a store or shopping environment have been the subject of interest to most store operators or businesses. In most instances, store operators are in the dark about how customers and potential customers behave or interact with products of interest on store shelves and the subsequent placements, replacements or lack thereof. It is reasonable to expect potential customers to pick up the products they are about to purchase or evaluate. What is lost is the lack of ability to discern whether a product was picked up or not by a potential customer or if the customer had any engagement with the product at the location of interest. In some instances, the picked up product may be returned to a different location of the store or shop.

Most products do not have tags that may be used to follow the movements of the products once they are placed on the shelves. When and where tags are used, the purpose remains monitoring and preventing theft of those products. While this is valuable, the connectivity and link with the product and the store seem limited to the theft prevention system where for the most part, a message will be sent if there is unauthorized taking of the product or pilferage.

There is an increasing need to learn how customers interact with the products on the shelves and practically what products are lifted or not at all in the life cycle of products in a store. Up till now, the best approach to this information would be to carry out surveillances or monitoring of some sort that may become an annoyance to customers who may prefer to maintain their privacies, even if in a store environment.

From the foregoing and more, it will be appreciated that what is needed in the art is a system that allows the store operator or management to learn about the interaction between the customer and a product of interest in the store environment prior to, or as they make the purchase decision. Such system is disclosed and claimed herein.

### SUMMARY

In one embodiment, a system is provided for tracking the interaction between a customer and a product in a location of interest. Such interaction may include if the product is picked up or returned to the original location or left in a secondary location away from where it was first taken.

In another embodiment, the system provides a means to monitor the movement of the product that may include an expanded solution to product theft and control against such pilfering.

### BRIEF DESCRIPTION OF THE DRAWINGS

FIG. 1 illustrates a flow process for monitoring the interaction of a product according to an example embodiment.

FIG. 2 illustrates a more-detailed flow process for monitoring the interaction of a product according to an example embodiment.

### DETAILED DESCRIPTION

In an example embodiment, a system is established to monitor and record the interaction of customers and related users in a retail environment or in a location of choice wherein the need to monitor inventory or stock is desirable. An initial condition of the system is preferably built to recognize the products that are either in inventory or used for any intended outcomes. Such recognition may include a database of the inventory located either in the store inventory system, a server notwithstanding the situs of the server, or in the Cloud wherein access to the data can be made from any relevant control points set by retailers or their agents. A product of interest is preferably tagged with an identifier prior to placement on the shelves, racks or other suitable accessible point in the retail environment.

Although reference herein is made to a retail environment, the system may be utilized in any environment of choice that includes the monitoring of material or merchandise, whether that is for wholesale, retail, inventory management, or the like. Such tagging may be made with unique identifiers such as Radio-Frequency Identification (RFID) tags, bar codes, or other identification systems readily available or later discovered. Products that are uniquely identified may now be placed in the system by use of aspects of near field communication (NFC) or other contactless (CTLS) process tag linked up with a sensor connected with the system. Understandably, the product and tagging of the system may at different times and conditions, not be enabled as part of the communication and monitoring. In such instances, an enabling check may preferably be made to assure that both the product and the enablement of the system are assessed usable according to the example embodiments.

In the present embodiment, the system preferably includes and provides independent nodes that may be linked together in a master-servant relationship wherein the master is programmed or coded to communicate with elements of the retailer's system. Communication between the independent nodes or the servant and master dependencies may preferably be accomplished by use of low power microcontrollers and an antenna or Bluetooth interphase. When an NFC tagged item is introduced into an area or location, the servants are preferably programmed to connect with the item and the master. It is practical to link many servants to a master in each location in the store or retail enterprise. This connection and loss of connection provide at least a means to monitor the interaction in the store or retail enterprise. According to some example embodiments, RFID tagged items preferably have unique identifiers with a central control wherein the connection provides particular reference to address the typical challenge of general identification of products in the retail environment.

In an example embodiment, each area of interest in the retail environment is preferably provided with a communication system that monitors the master-servant relationship of the items that are tagged with RFID. In action, a product having an RFID tag is placed in an area with connectivity; when and if that product is moved and not returned within a set period of time, the system records that movement as a lift. A lift that is longer than desired triggers other pre-programmed or pre-configured activities. A lift example may be as short as 60 seconds or extended, depending on the environment wherein such monitoring is of interest. In some instances, and depending on the intent of the monitoring, the times between lifts or placements may be extended as desired for effective monitoring or better understanding of the relationship between the customer and the product or item on the shelf, rack or location of interest. If there is a disconnect due to the product not being recorded in the system between the tagged product and the system, the need to have such product entered into the system is shown and such update adds the product to the inventory.

Communication between the master, servant and controlling system may by necessity, be Internet ready. Given the prevalence of Internet protocols on most applications, the communication systems may need to be adaptable to function in the province of Internet-ready applications. It is reasonable to imagine information storage and communication to be Cloud ready or adaptable to function with Cloud programming. Cloud storage and programming allows for the now-known benefits beyond what is available to a server-based system—providing redundancies with given packages that may also be managed from various locations. A broader construct is the “Internet of Things” (IoT) environment wherein communication and interconnectivity of the master and servant application can be properly operable.

According to some example embodiments, a monitoring system is preferably created to address the interaction between the customer and the product as it pertains to the lifting or placing of a product in a retail environment. When a customer attempts to select a product from the shelf at a store, the customer may by necessity, either take the product to the checkout process or put it back on the shelf. In some cases, the customer might hold on to the product without buying or paying for it. In other instances, the customer may reshelf the product elsewhere for one reason or another. This interaction is of importance to retailers as there is need to know where a product is or how the interaction transpires between the customer and product or object of interest. The lift-and-reshelf process if not performed as routinized, provides needed information to the retailer about customer reaction or interaction with the products.

When the system utilized to monitor is not formalized to obtain the needed information in a retail environment, the system provides alerts to sensitize the retailer or control system about the need to have such sensors built into the product cycle. For portable systems, the introduction of power sources to keep both the servant and master systems may include battery packs for each component as against a direct link to a wall or pre-wired power source. It is also reasonable to imagine a system wherein the unauthorized lifting or placement of the product or object of interest may be relatable to a control or management system that may serve to provide inventory integrity and sustainability.

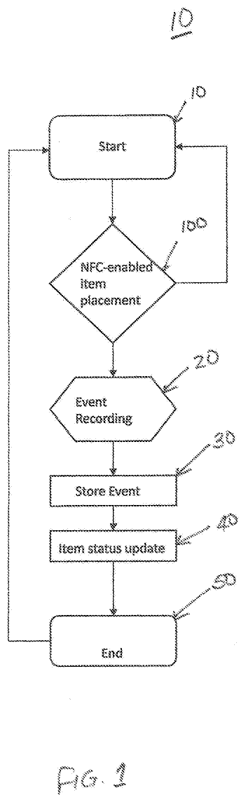

Referring now to FIG. 1, a system 10 is initialized 11 and having capacity or programming to monitor and detect product lifts or placement in the location or facility of interest. The initialized step includes confirmation of presence or lack of the data collection site; whether at the location of monitoring; on a server wherever that is located on in the Cloud. Said database preferably includes pertinent information about the inventory of interest, including, but not limited to product description, tag identification, or other information that may be useful for the monitoring process. Reasonably, product age and time in residence may be included as needed. In some instances, Universal Product Codes (UPC) may be utilized to provide an efficient means to gain access to the full description of the product or package of interest. Utilizing the system, product placement or lift 100 may be noted via a contactless (CTLS) or near field communication (NFC) process. Each event in the placement, enablement, or lift in the system is preferably recorded in a location of choice. The event 20 is preferably transmitted to a server, cloud or such storage location to maintain the monitoring events.

Where the initial placement is recorded and transmitted in step 20 as a recordation of the product or item that is monitored, an event 30 that may include a lift, replacement, relocation of the item of interest preferably gives way to the next step of updating the state, location or other status 40 of the product or item in the system. It is notable that each of these steps may preferably be located or noted in the repository of information about the product. As this cycle ends 50, the cycle of monitoring of an item continues wherein the next logical step is a reset of the process to provide monitoring of the item or product of interest.

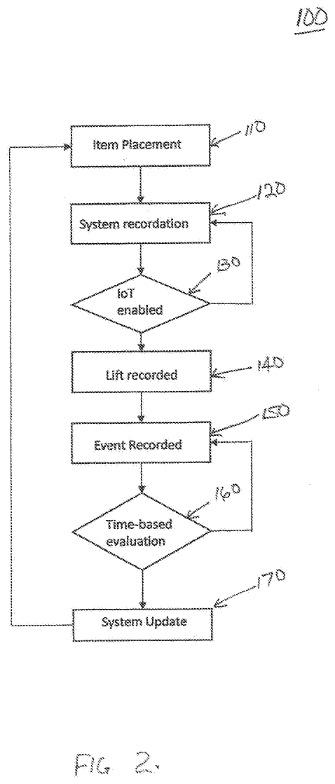

Now, FIG. 2 refers to a system 100 wherein the item of interest is recorded as recognized in the flow of the monitoring process 110. If UPC or other identifiers of the item is recorded, the system may preferably and operably be adapted to assess and maybe, preconfigure said inventory or item in the system 120. A monitoring system may be linked in an Internet of Things (IoT) environment wherein if said recordation or link 130 is not enabled, the system may reinitialize to begin the process at initial placement 110 or system recordation 120. The use of IoT relies on the data or information storage in 130 to adapt to any store or location event. As an object or item is lifted or relocated 140, the system records such shift or replacement according to the setup of the system—locally or in the cloud 150. A time-based lift may preferably be programmed 160 into the process. Depending on the process, an update 170 of the system and analyses of the lift, replacement may be transmitted to the repository of information as required for this process.

In use, when a product under monitoring is removed from a preferred location such as a rack, shelf or other predetermined location, the system records that removal as a lift in the system when and if the said lift is beyond an expected duration of what is deemed reasonable. That lift, regardless of purpose is information useful for the determination and data collection to document customer interaction with the item. Some product lifts may end when the product is placed in a different location within the retail environment. Other lifts may proceed to the point of sale wherein the sale process addresses the inventory issue for the retail environment and may be useful for restocking or other inventory management processes.

Having thus described some example embodiments, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed is:

1. A system for item monitoring, the system comprising:
a master controller configured to communicate with at least one database, the at least one database configured to store information about a plurality of items, the stored information including a location for each of the plurality of items and a unique identifier associated with each of the plurality of items;
multiple sensors located in an environment, each of the multiple sensors are configured to communicate with the master controller as servant devices, and each of the sensors configured to detect at least one of near field communication (NFC) tags or radio frequency identification (RFID) tags; and
multiple items located in the environment, each of the multiple items including an NFC tag or an RFID tag, the NFC tag or the RFID tag including the unique identifier associated with the item,
wherein each of the multiple sensors are configured to link with the NFC tag or the RFID tag of at least one of the multiple items to obtain the unique identifier associated with the item, and transmit the unique identifier with the master controller in response to linking with the NFC tag or the RFID tag, and
wherein, in response to the master controller receiving the unique identifier from one of the multiple sensors, the master controller is configured to update the location of one of the multiple items corresponding to the unique identifier according to a location of the one of the multiple sensors which transmitted the unique identifier to the master controller.

2. The system of claim 1, wherein the environment is at least one of a retail environment, a wholesale environment, an inventory management environment or an internet of things (IoT) environment.

3. The system of claim 1, wherein the database is configured to store at least one of a location of the master controller or locations of each of the multiple sensors.

4. The system of claim 1, wherein each of the multiple sensors are configured to communicate with the master controller via at least one of a wireless antenna and a BLUETOOTH interface.

5. The system of claim 1, wherein each of the multiple sensors includes a battery pack configured to power the sensor.

6. The system of claim 5, wherein the master controller includes a battery pack configured to power the master controller.

7. The system of claim 1, wherein:
each of the multiple items includes an NFC tag having the unique identifier associated with the item; and
each of the multiple sensors is configured to link with the NFC tag to obtain the unique identifier associated with the item.

8. The system of claim 1, wherein:
each of the multiple items includes an RFID tag having the unique identifier associated with the item; and
each of the multiple sensors is configured to link with the RFID tag to obtain the unique identifier associated with the item.

9. The system of claim 1, wherein:
the at least one database comprises a cloud server database; and
the cloud server database is configured to store at least one of product description data for each of the multiple items, tag identification data for each of the multiple items, product age data for each of the multiple items, time in residence data for each of the multiple items, or universal product code (UPC) data for each of the multiple items.

10. The system of claim 1, wherein a first one of the multiple sensors is located in a first area of the environment, and the master controller is configured to:
detect a first placement location of a first one of the multiple items in the first area of a retail environment, in response to the first one of the multiple sensors linking with the first one of the multiple items;
record the first placement location of the first one of the multiple items into the database according to the unique identifier associated with the first one of the multiple items,
detect a lift of the first one of the multiple items in response to the first one of the multiple sensors failing to link with the first one of the multiple items for a set period of time; and
record the lift of the first one of the multiple items into the database.

11. The system of claim 10, wherein:
a second one of the multiple sensors is located in a second area of the environment, the second area of the environment different than the first area of the environment; and
the master controller is configured to:
subsequent to detecting and recording the lift, detect a second placement location of the first one of the multiple items in the second area of the retail environment, in response to the second one of the multiple sensors linking with the item, and
record the second placement location of the first one of the multiple items in the database as a relocation event of the first one of the multiple items, according to the unique identifier.

12. The system of claim 11, wherein the master controller is configured to,
subsequent to recording the relocation event, record an item return event in response to detecting that the first one of the multiple items has linked with the first one of the multiple sensors.

13. The system of claim 10, wherein the set period of time is at least sixty seconds.

14. The system of claim 1, wherein:
the master controller is a first master controller;
the system further comprises a second master controller; and
the second master controller is configured to communicate with a portion of the multiple sensors.

15. The system of claim 1, wherein the master controller is a low power microcontroller.

16. A method for item monitoring, the method comprising:
configuring a master controller to communicate with at least one database, the at least one database configured to store information about a plurality of items, the stored information including a location for each of the plurality of items and a unique identifier associated with each of the plurality of items;
detecting, by one of multiple sensors located in an environment, at least one of a near field communication (NFC) tag or a radio frequency identification (RFID) tag of one of multiple items located in the environment, wherein each of the multiple sensors are configured to communicate with the master controller as servant devices, and each of the multiple items including an NFC tag or an RFID tag, the NFC tag or the RFID tag including the unique identifier associated with the item;
linking, by the one of the multiple sensors, with the NFC tag or the RFID tag to obtain the unique identifier associated with the one of the multiple items;
transmitting by the one of the multiple sensors, the unique identifier associated with the item to the master controller; and
updating, by the master controller, the location of one of the multiple items corresponding to the unique identifier according to a location of the one of the multiple sensors which transmitted the unique identifier to the master controller, in response to receiving the unique identifier.

17. The method of claim 16, wherein the environment is at least one of a retail environment, a wholesale environment, an inventory management environment or an internet of things (IoT) environment.

18. The method of claim 16, wherein the database is configured to store at least one of a location of the master controller or locations of each of the multiple sensors.

19. The method of claim 16, wherein each of the multiple sensors are configured to communicate with the master controller via at least one of a wireless antenna and a BLUETOOTH interface.

20. The method of claim 16, wherein:
each of the multiple sensors includes a battery pack configured to power the sensor; and
the master controller includes a battery pack configured to power the master controller.
